(19) United States
(12) Patent Application Publication
(10) Pub. No.: US 2012/0179616 A1
(43) Pub. Date: Jul. 12, 2012

(54) PROCESS TO TRANSFORM A SOCIAL SYSTEM INTO A MORE VITAL, MORE SUSTAINABLE LIVING SYSTEM

(76) Inventor: Mark H. Macy, Louisville, CO (US)

(21) Appl. No.: 13/409,576

(22) Filed: Mar. 1, 2012

Related U.S. Application Data
(63) Continuation of application No. 12/287,875, filed on Oct. 15, 2008.

(51) Int. Cl. G06Q 99/00

(52) U.S. Cl. 705/319

(57) ABSTRACT

A vitality ratio is disclosed to monitor the well-being of nation-systems and other social systems. In an example, V=R:N (economic vitality [V] is determined by the natural resources [R] available to a social system, in relation to the system's resource needs [N]). With definitions of products, natural resources, social systems, and other related terms, said ratio can be programmed into a system-wide computer network, accepting input relating to needs and resources from throughout the system and issuing an alert in the event of a negative ratio (i.e., in which needs for any specific resource exceed the system's access to that resource).

### BACKGROUND OF THE INVENTION

1. Field of the Invention

This is a continuation of U.S. patent application Ser. No. 12/287/875, filed Oct. 15, 2008: a process to transform a social system through use of a new ratio and new definitions, into a nested living system that is composed of people and products and that consumes resources in such a way as to keep the social system vital and sustainable over time as the variables in the ratio are monitored on a computer network and adjusted as necessary to keep the needs (to sustain people and products) in line with available resources. As we see later in the description (6), this is not just a conceptual transformation, but a real transformation of a social system that, when fully implemented, will have true and lasting effect on the social system and its well-being by making it more vital and more sustainable.

2. Description of Prior Art

This is a natural but heretofore undiscovered concept and process; there is no prior art in which a social system is transformed, by ratio and definition, nor by any other means, into a vital, sustainable living system which is composed entirely of “basic building blocks” of people and products, and which consumes natural resources. Essentially, people and products are to a social system what cells and molecules are to a biological system like the human body: Building blocks. Comparisons can be made to prior art in the studies of molecular and cellular biology—in particular, the view of cells and molecules as basic building blocks of a biological system such as the human body. (see Pearson)

While there is no prior art in the area of social systems and economics that refers directly to this transformative building-block scenario with a ratio between clearly defined needs and resources, some art may have similar, useful components. (see Coelli, Caves, Kosala, Kagami, Brinkley, Feigin, Dirks, and Dulaney)

Coelli's focus on agricultural production in terms of supply and demand is similar to the Vitality Ratio as it might apply to a poor country, in which population and food supply may be the most crucial variables in the overall economy. In a modern industrial or post-industrial society, however, agriculture is but a small proportion of the overall economy. Vast resources (metals, minerals, petroleum . . . ) are used to sustain the immense infrastructure of products (transportation and communication networks with their cars, trucks, airplanes, buses, computers, phones, TVs; large homes, skyscrapers, stadiums, schools and universities, hospitals, government complexes . . . ). The Vitality Ratio takes into account the entire infrastructure and the resources necessary to sustain it.

Further, Coelli and some other economic ideas (e.g. Caves) base themselves on the Malmquist Index, which measures labor and capital to compare the productivity of two different economies (businesses or regions or nations, for example). Labor refers not to the people themselves (population), but to human effort and exertion. Capital refers to wealth, which includes symbolic valuation, i.e. money. As we see below (10), the Vitality Ratio ignores symbolic valuations (costs, prices, currency) in order to deal exclusively with substantial variables: people, products, and resources. With the Vitality Ratio, ignoring abstractions and focusing on people, products, and resources gets a clearer pulse of a social system's true “state of health”.

Kosala discusses methods of web-mining from the vast and diverse information on the Internet. Such techniques will certainly be useful for the Vitality Ratio, especially at first, when data fed into the ratio is gathered from existing sources. Eventually (10), if and when the ratio becomes well-ingrained in the workings of society, standards will be in place at all levels to serve data into the system in compatible ways. At that time web-mining techniques will no longer be necessary to maintain the Vitality Ratio. The data-flow will be a self-sustaining process at all levels of a social system that employs the Vitality Ratio in its intended ultimate form.

Kagami, Brinkley, Feigin, Dirks, and Dulaney all introduce effective ways to inventory. Product inventory will always play an important role in the Vitality Ratio, but no more important than tracking demographics and resources.

Further cases of prior art are explored below in implementation (10).

While prior art relating to economics and social systems could be useful in the implementation of the Vitality Ratio, this application takes a major next step beyond all prior art in defining a process that transforms a social system into a vital, sustainable system composed only of natural, substantial things—people and products—that are monitored, in relation to the natural resources the system consumes, through the use of a ratio operating on a computer network.

### OBJECTS AND SUMMARY OF THE INVENTION

One object of this invention is to provide a process, based on a ratio, to help ensure the economic stability and well-being of nations and other social systems.

Another object of this invention is to provide a ratio which, once implemented, will transform a social system into a nested living system which is composed of basic building blocks (people and products), and which consumes natural resources to nourish the system.

A further object of the invention is to provide a transformative process by which the transformed social system will begin to develop and evolve in a more cohesive, vital, and sustainable manner once the process is adopted.

It is a further object of this invention to provide a ratio that can be programmed into a computer network in order to monitor the variables inherent in the ratio—those variables being 1) the material and energy needs for sustaining people and products (the “building blocks” of a social system) and 2) natural resources (petroleum, timber, metals, arable land, and other “foods” consumed by a social system) to satisfy those needs—in such a way that the system issues alerts (e.g. emails, reports, printouts . . . ) whenever the program detects economic conditions begin to destabilize.

It is a further object of this invention to provide a new set of five classifications of terrestrial living systems and concise definitions for those five terms as well as definitions for several other terms that help make the ratio and transformative process viable.

### DETAILED DESCRIPTION OF THE INVENTION

The Vitality Ratio (V=R:N) means that a social system's level of vitality [V] is determined by how completely its material and energy needs [N] can be satisfied by available resources [R], and it is viable only in conjunction with certain assumptions: That living systems can be classified into five groupings based on how organized they are (social systems being one of those groupings), that life is a nested structure (systems within systems), that the nested structures of any of the five types of living systems can be disaggregated conceptually into basic building blocks (people and products being the building blocks of a social system), that every living system is nourished by ingested materials and energies (resources providing nourishment for a social system), and that the ratio between the system needs on one hand and the materials and energies available to satisfy those needs on the other hand plays a fundamental role in the vitality and well-being of the system.

### 1. Five Classifications of Living Systems

There are countless varieties of living systems in our world that can be classified in various ways. The following way involves just five basic groups determined by how orderly life is within them and around them:

Biosystems are the somewhat independent plants and animals of Earth (birds, trees, people, cats, frogs . . . ), as well as bacteria, viruses, and other organisms of all sizes. Things are very well-organized inside a biosystem but more or less chaotic outside, depending on whether it inhabits an ecosystem, a social system, or an ordisystem.

Bio-subsystems are the inner parts of biosystems and their internal nested systems, such as a heart within a person, or a heart cell within a heart, or tiny organelles within a heart cell. Life is very well-organized both inside and outside a bio-subsystem, which can't survive on its own and is “locked in” to its host system.

Ecosystems (forests, oceans, jungles, savannahs . . . ) are the wild places whose members (biosystems, social systems, and ordisystems) fight and kill each other for nourishment, territory, and defense. Ecosystems are rife with conflict and disorder inside and out.

Ordisystems (honeybee hives, ant colonies, and termite colonies, for example) are tightly knit communities of biosystems living together compatibly within a protective enclosure or membrane, with the clear understanding that the needs of the community outweigh the needs of individual members.

Social systems are human groups ranging in size from families and friendships to nations and religions. Social systems aren't as tightly knit as biosystems or ordisystems, in which the needs of the group clearly outweigh the needs of individual members. Considering the many forms of government with their different policies for or against freedom and/or equality (autocratic, democratic, socialistic, and so on) it is apparent that humankind struggles perpetually to find a balance between the needs of individual human beings to be free (as though living in an ecosystem) and the needs of their groups to be stable (as though the people were part of a biosystem or ordisystem).

If we could step back and observe all the life forms on Earth, we'd see that most but not all fit neatly into these five groupings. Some seem to be hybrids. Or, stated differently, the five groupings don't have a solid line between them; they sort of blend together as in the following table, which lists them in order of how organized they are, from most organized (top) to most chaotic (bottom).

| Types of Life Forms | Examples and descriptions |
|---|---|
| Bio-Subsystems | Organs, body cells, and organelles are orderly inside, as well as outside in the cozy and |
| | complex, tightly organized world around them. |
| (hybrid example) | E. coli bacteria in the human gut are parasites (biosystems), but they behave like natural |
| | parts of us (bio-subsystems), helping us to digest the food we eat. |
| Biosystems | People, trees, cats, bees, and bacteria are orderly inside, but more or less chaotic outside in |
| | their surrounding ecosystems, social systems and ordisystems. |
| (hybrid example) | The Portuguese man o' war looks like a jellyfish (biosystem), but it's actually a colony |
| | (ordisystem) composed of four kinds of specialized polyps living together tightly within the |
| | confines of the organism. The polyps can't survive on their own; one polyp digests food for |
| | the colony, another procreates, and so on. The colony is so well-integrated that it behaves |
| | like a crude biosystem, floating with the current (unable to swim), but stinging and eating |
| | fish that swim into its tentacles. |
| Ordisystems | Bee hives and ant colonies are organized inside, but not outside in the surrounding ecosystem. |
| (hybrid examples) | Military boot camp, formal meetings, religious ceremonies, some communist-totalitarian |
| | societies, and other social systems with rituals, tight regulation, and specialized roles are |
| | sometimes so regimented that they're compared to insect colonies. |
| Social Systems | Families, companies, and nations are typical social systems—subject not only to their |
| | members' noble side (wisdom, empathy, honesty, trust . . .), but also to their fears, envy, |
| | resentments, and other savage moods, which stir conflicts and tensions within the group as |
| | well as with other social systems, so the typical social system rarely becomes as orderly as |
| | a biosystem or ordisystem. |
| (hybrid examples) | Run-down neighborhoods of gangs, drug dealers, pawn shops, porn shops, and liquor |
| | stores inspire the phrase, “It's a jungle out there,” because of the violence, desperation, and |
| | predation among the people. |
| Ecosystems | Jungles, forests, coral reefs, savannahs . . . Chaos and conflict are the rule, as living |
| | systems in the ecosystem kill and eat each other to survive. |

So this is one easy way to classify the myriad living systems on Earth—by how orderly or disorderly things are inside and outside the system—and it helps set the ground work for a more natural form of economics that can make the Vitality Ratio viable.

### 2 Life's Nested Structure

Life on Earth is a chain of nested systems (that is, systems within systems within systems . . . ). Looking inside a biosystem like the human body we find several large bio-subsystems, including nervous system, circulatory system, and digestive system. Each major bio-subsystem, in turn, is composed of smaller bio-subsystems—organs, glands, tissues . . . which are composed of cells . . . downward . . . inward . . . .

Looking outside the human body, we are part of several social systems, including perhaps family, company, church (or mosque or temple or synagogue), clubs, professional organizations, and friendships. These in turn may compose larger and larger social systems. Family, for example, is part of a neighborhood, which might be part of a city, which is part of a state or province, which is part of a nation, which is a member of international affiances . . . upward . . . outward . . . .

The human being, then, like any other living system on Earth, is one link in a nested chain of living systems, which for us humans include body cell within organ within person within family within city within nation. But that complex condition does not lend itself easily to computer analysis, so we can break the system down into basic building blocks.

### 3. Basic Building Blocks

Although life on Earth is a vast array of nested systems, it helps to understand living systems as being composed of basic building blocks. This is a simpler, more practical view of life, and it is also accurate, since all of the chains of nested life within a living system do come together in those “basic building blocks.” Some examples:

A biosystem example: The basic building blocks of a human being are body cells (bone cells, muscle cells, blood cells, nerve cells . . . ) and molecules (water, carbohydrates, fats, proteins, hormones, enzymes . . . ). The body cells work together and use the molecules to keep the complete system alive and healthy.

An ordisystem example: The basic building blocks of a honeybee hive are the bees themselves and their products (honey, royal jelly, honeycombs . . . ). The bees work together and use the products to keep the colony alive and healthy.

A social system example: The basic building blocks of a nation are people and products (houses, laptop computers, clothes, foodstuffs, cattle, highways, pets, computers, TVs, ships, stores, farms, factories . . . ). The people work together and use the products to keep the nation alive and healthy.

Ecosystem example: The basic building blocks of a forest are biosystems (trees, squirrels, wolves . . . ), ordisystems (ant colonies . . . ), and social systems (forest homes and communities . . . ), plus the products those systems need . . . which often include each other. Hence the tendency of members of an ecosystem to fight, subordinate, consume, and kill each other to survive.

So a nation, though a complex nested system, can be perceived more simply and usefully (and still accurately) as the collective structures and activities of all of its basic building blocks—people and products. Note that this new definition excludes much of what is commonly considered to be part of a nation—forests, mountains, empty city lots, wild animals, and so on. Only the people and products compose the living social system.

Nation-system. At this point, then, it is important to begin using the term “nation-system,” for the sake of clarity, to distinguish the living structure of people and products from the more common meaning of “nation,” which is essentially everything within the political borders of a nation-state.

### 4. Feeding the System

Living systems must absorb part of their environment to satisfy their structural and energy needs inside. Examples:

Biosystems: People and trees, as well as lions and rabbits and insects, eat food, drink water, breathe air, and absorb sunlight. These raw materials are ingested and used to satisfy the material and energy needs inside the biosystem.

Ordisystems: Honeybee hives consume nectar from flowers, which is used inside the colony to make honey.

Social systems: Nation-systems consume natural resources (metals, timber, oil, ocean fish, water supplies, minerals in farmland, sunlight, wind power . . . ). These raw materials are ingested and used to satisfy the material and energy needs inside the nation-system—that is, some of the resources are broken down into pieces that become part of the products and people in the nation-system, and some resources are converted to energy that gives motion, heat, light, and sound to the people and products. To be clear, resources are not part of a nation-system until they have been ingested by the nation-system to become products (in either matter or energy form) or to be consumed by people.

So natural resources are the “food” of asocial system.

Now we'll compare conventional economics with new economics made possible by the Vitality Ratio and its related classifications and definitions.

### 5. Definitions and Concepts

| Definitions and | | |
|---|---|---|
| Concepts | Vitality Ratio (New) | Conventional Economics |
| Basic Economic | Tracks three very basic and clearly | Employs statistics and math for numerical analysis of |
| Variables | defined economic variables of society: | abstract and concrete economic forces in society such as |
| | people, products, and resources. | interest rates, capital, labor, GDP, income, consumer |
| | | price index, corporate profits, return on equity, prime rate, |
| | | and opportunity cost. |
| What is a | A nation-system consists only of its | Although sometimes regarded as a group of people with |
| Nation? What is a | basic building blocks—the people | common heritage and culture (as in the Jewish Nation or |
| nation-system? | who are directly involved in the | the Cherokee Nation), a nation is more widely thought of |
| | activities of the social system, and | as a nation-state—people living under one government |
| | all of the products they use. Anything | within territorial borders (as in the member states of the |
| | that is not a person or product is not | United Nations), along with their personal and collective |
| | a part of the nation-system. | possessions and territorial claims. By that definition, a |
| | | nation would include everything within the national borders, |
| | | minus visiting foreigners and foreign-owned property, plus |
| | | citizens traveling abroad, plus outside products that are |
| | | owned by the citizens and groups within the nation . . . |
| What are | Human beings taking part in the | In politics and law, “people” are generally citizens of a |
| people? | activities of a nation-system (or | recognized jurisdiction, as in “the People of Rome” or the |
| | other social system). | “People's Republic of China” or The People vs. Joe |
| | | Smith.” |
| What are | Products are the substantive things | In business and marketing, a product is something that |
| products? | (energetic and material, living and | satisfies a want or need, sometimes called “merchandise.” |
| | non-living) that people within a | It can also include services such as hours of maintenance. |
| | nation-system (or social system) use, | It also sometimes includes symbols such as ID and serial |
| | and which keep the nation-system | numbers. |
| | functioning in its internal and/or | |
| | external activities. | |
| What are natural | Natural resources are the “food” of | In traditional economics, natural resources were land, |
| resources? | nation-systems (and other social | labor, capital, and entrepreneurship. Today at least three |
| | systems). They are outside the social | of those four things are called “factors of production” |
| | structure of people and products | rather than “natural resources,” and natural resources are |
| | (not necessarily outside the territo- | usually defined as raw materials in the environment. |
| | rial borders), and they are useful | Sometimes those raw materials are also called |
| | and available to the system. Once | “commodities,” although that term can also apply to |
| | consumed and put to use in the | products widely available in the open market. So in conven- |
| | nation-system, they become products, | tional economics the distinction between products and |
| | and they move to the other side | resources is often blurred. |
| | of the Vitality Ratio, becoming | |
| | part of the social system. | |
| What makes an | A social system's needs are in line | The system continues to grow, to use more resources, to |
| economy healthy? | with its resources (V = R:N) | produce more products, and to show higher profits, |
| | | greater value, and more wealth, in perpetuity. |

As we can begin to see from the above comparisons, these new definitions and concepts that accompany the Vitality Ratio can make a nation's economy and general state of well-being much more manageable.

### 6. How the Vitality Ratio Works

The Vitality Ratio (V=R:N) transforms a social system into a more vital, more sustainable living system, similar to how a group of shrieking kids on a playground are transformed into an orderly classroom of students when recess ends (see Mather) . . . or how a group of young men from diverse walks of life (petty thieves, top students, drug users, artists, athletes . . . ) are transformed into an efficient platoon during army training. In all cases, social systems are transformed by the rules, routines, goals, and standards to which the members conform. (see UCSF, ITU, Feldman, and Schmidt.) The Vitality Ratio, with the rules, routines, goals, and standards inherent in the ratio, keeps a social system's clearly defined needs in line with the resources available to satisfy those needs, and in doing so keeps a social system vital and sustainable.

The resources consumed by a social system (as represented by the ratio) are a principal factor determining the economic vitality of a social system, just as the food that a biosystem eats is a principal determining factor in the health of the biosystem. If there are enough appropriate resources to satisfy the needs of the social system—that is, the needs of the people and products that compose the social system—then the system can be healthy and vital. If there are shortages of appropriate resources, the well-being of the system begins to diminish.

The aim of the Vitality Ratio is simple: To provide on-going information about a social system's well-being (via system-wide computer network) to allow the system (via its regulators) to sustain a balance between needs and resources. Generally speaking, throughout history there seems to be a tendency among nations toward ever-increasing needs (more people using more products), so maintaining a balanced ratio in the future will involve, in large part, finding ways within nation-systems to reduce needs and to increase resources in safe, healthy ways.

### 7. Via Nationwide Computer Network

Programming the Vitality Ratio into a nationwide computer network like the Internet would allow the monitoring of the economic vitality of a nation-system. The elaborate, high-speed computer network will keep track of many variables in exhaustive detail, including:

A nation-system's needs: population and demographics, per-capita consumption of products, imports and exports, recycled products, product life expectancy, products in use, products in storage in warehouses, products on store shelves, products stored in homes and offices, nutritional qualities of consumable products, wholesome vs. unhealthy consumables vs. medicinal consumables etc. Eventually every home, office, and school will probably keep a running inventory of all products they acquire and use, but to begin with, the lowest level of reporting could be the retail merchants who sell products to families, offices, schools, and other end users. Most of them already keep sales figures and running inventories that could be plugged into the system.

A nation-system's resources: reserves of raw materials owned by the nation and its people, foreign raw materials accessible to the nation-system, renewable vs. nonrenewable resources, imports of foreign products, natural energy such as sunlight and wind, and more.

The computer program could be written in any of several computer programming languages to issue alerts (emails, reports, printouts, etc.) whenever the needs for any resource exceeds its availability; to run algorithms while accessing its vast database of people, products, and resources to determine possible solutions; and to output alerts and suggestions, in such forms as reports or emails or printouts, for remedial action. Said suggestions and remedial actions could be executed by the responsible regulatory agencies.

It falls well within the knowledge and capabilities of most modern hardware and software engineers to design a simple system based on variables of the Vitality Ratio to process the complex, widespread information as laid out in this application. It could involve using any of a variety of software programs, computers, and operating systems to track the key variables: The resource needs of the people and products, and the resources available to satisfy those needs. The difficulty is not in the hardware and software design, but in the sheer quantity of people, products, and resources that make up the workings of a modern nation-system; the growing varieties of products; and the incompatible methods (e.g. units of measure) used today to quantify products and resources. The difficulty is in gathering data and putting it in a compatible form for processing.

Adjusting needs and resources as necessary in response to the alerts will help to ensure a balanced ratio, and that in turn will prevent or at least alleviate symptoms like those listed below.

### 8. Symptoms of a Low Ratio

When The Vitality Ratio goes negative—when needs exceed resources—various economic problems can develop, some simple and short-lived, others devastating and long-term. Symptoms of a negative ratio include:

Fewer products per capita. When needs for particular resources exceed supplies, there are fewer products made from those resources—fewer products to go around.

Rising prices. Carnivores during a drought fight more aggressively over a carcass, trees in a dense forest grow as tall as possible to compete for sunlight, and social systems facing a shortage of a particular resource pay more money to get it and its related products. Freezing or flooding or drought can ruin thousands of acres of raw farmland in any given year, resulting in shortages of wheat or rice or soybeans or oranges. Like the toughest carnivores and the tallest trees, the highest-paying social systems (processors, stores, consumers, etc.) get the goods. When resources (in this case, fertile farmland) are insufficient to satisfy needs, expensive products spread through society, and prices rise.

Inflation. As people and groups pay higher prices for the scarce resources and related goods, they demand more compensation for their own goods and services, and prices spiral upward.

Recession. As inflation spirals and things grow scarcer and get more and more expensive, it gets harder for social systems like companies to keep doing what they do, so things start to slow down. They cut jobs and maybe close their doors. This is recession, which often follows on the heels of unchecked inflation. Recession can usually be traced back in time through the inflation, to a negative ratio in which needs exceed resources. Recession is an unwitting effort by social systems to reduce their needs.

Depression. If recession doesn't adequately reduce needs, depression follows. As the unemployment lines grow and more commercial-industrial organs die within a nation-system, the surviving social subsystems and the nation-system as a whole begin to weaken dramatically, like an old man on his deathbed. As more businesses fold and the nation-system's physical structure continues to decay, products are being manufactured and distributed in inade-quate numbers. Resources may be growing plentiful, but the nation-system has no way to digest them, so they are not really resources anymore . . . just as food is no longer really food to a dying man. The nation-system is on the verge of depression. It is dying. Fortunately, nation-systems are not biosystems. When nation-systems “die” during a severe depression, they can rebuild.

The preceding symptoms of a low ratio are usually experienced by more advanced nations with a growth economy and can usually be traced back to needs outstripping resource availability. They could be alleviated, maybe eliminated, by The Vitality Ratio, which would raise a red flag as soon as needs begin to exceed resources, and a series of options (cutting back on particular products for awhile, finding replacement products or resources, or acquiring more resources from specific sources, for example) would be offered to help restore the balance.

The preceding symptoms are most debilitating to advanced nation-systems whose infrastructures of people and products have grown fairly complex. Poor nations are not as vulnerable to sophisticated symptoms. Their needs are different. The usual cause of a low ratio in poor countries is overpopulation, and the following are among the most common symptoms:

Famine. Primitive cultures and other poorly integrated societies don't have a diversity of products. They need a steady supply of resources to feed the people, but only a modest amount to sustain the humble infrastructure. So, the usual cause of a severe resource shortage in a poor nation is overpopulation, and the chief symptom is famine. While the elaborate infrastructure of the advanced nation-system crumbles, poor nation-systems are riddled by starvation and disease when their needs outstrip resources through overpopulation.

Mass execution. When resources are in serious short supply, envy and desperation often lead to gross inhumanity. Mass execution is an unconscious, desperate effort by factions in a nation-system to solve economic problems by reducing needs. Just as a man whose family is starving might steal or even kill to feed them, a nation-system suffering a severe imbalance between resources and needs often vents its frustrations in cruel and unjust ways. The targeted victims of mass execution might constitute a group within society that is unwilling or unable to conform to national objectives or regulations for such reasons as religious belief, ignorance, intertribal contentions, or geographic isolation. Through mass execution some nation-systems attempt to solve two problems—reduce needs and dissect an incompatible segment from the national structure.

Mass emigration. Occasionally there is an outpouring of people and products from a particular nation-system. Whether the group is exiled or feels pressured to flee for political or economic or religious reasons, it usually happens when the nation-system is suffering economic hardships—or, more specifically, when resources are in short supply. In the last half of the 20th Century, Africa had 5 million homeless, 125,000 Cubans fled to America in a “freedom flotilla,” 800,000 Afghans fled to Pakistan, 500,000 Vietnamese fled to Thailand, tens of thousands of Jews fled from the Soviet Union, and hundreds of thousands of Mex-icans poured into the United States. When mass emigration occurs, needs are reduced in the nation-systems left behind, and the receiving nation-systems take on the economic strains of rising needs.

Those three economic syndromes of poor countries could also be alleviated (maybe eliminated) by The Vitality Ratio, whose aim, again, is to sustain a balance between needs and resources. In a country prone to overpopulation, needs would be kept in check largely by a multi-level family planning program like the one that transformed China from a peasant economy to an industrial leader in the closing decades of the Twentieth Century. A family-planning program, along with education (and, of course, an infrastructure of transportation, communication, and electricity), would be the backbone of The Vitality Ratio in poor countries.

The last two symptoms mentioned here, below, can afflict any nation-system, rich or poor, when its needs outstrip its resources.

War. Like mass execution, war is often a desperate attempt by a nation to bring needs into line with resources. It's often waged to steal resources from another country, such as oil in today's world. War also reduces needs by removing many people from the equation—military and civilian casualties.

Ecological destruction. When needs exceed resources, nation-systems often become desperate enough to exploit the environment ruthlessly for more resources. When a nation-system becomes desperate, environmental concerns often take second seat to keeping the bloated structure well-fed, especially when leadership is weak or misguided. Land is ravag-ed, water and air are poisoned, and life cycles in the ecosystem are upset or devastated.

The Vitality Ratio would alleviate (maybe eliminate) war and environmental destruction along with the other symptoms by making sure needs did not exceed resources.

### 9. Two Main Causes of a Low Ratio in Today's World

Anything that causes the needs of a social system to increase (growing population or rising per-capita consumption, for example) and anything that causes the resource availability to decline (natural disasters, depletion of non-renewable resources, or resources lost by war, for example) can result in a low ratio in which needs exceed resource availability. Here we look at two of the leading causes today—uncontrolled population growth and growth economics.

Overpopulation. Of all the variables involved in needs and resources, none is as crucial as human population. Overpopulation has probably been the most pervasive negative ratio condition of humankind down through the ages, mostly because of high birthrate, but also resulting from such factors as mass immigration.

Experience around the world has revealed many devastating symptoms of overpopulation, including famine, war, environmental destruction, and mass execution. There will soon be 7 billion people on Earth, and devastating symptoms of unprecedented proportions are likely in many parts of the world unless we can get a handle on population growth very soon. The Vitality Ratio could allow nation-systems to do that.

Growth economics. While overpopulation is the main cause of a low ratio in poor countries, in some wealthy countries the main cause is high per-capita consumption and the growth economics that pushes it along. Modem economic thought is based on the belief that economic growth is the main measure of economic health and vitality, but it is an unnatural and dangerous belief. Unbridled growth in a biosystem is called cancer. Biosystems like the human body grow physically until they mature, then they sustain. That's what healthy societies would do. The always-grow-and-never-mature economic principle might have been important in the past in the drive to spread order out into the chaotic ecosystem by converting more and more land from ecosystem to social system, but today, as swelling nation-systems push up against each other in the global ecosystem, the economics of growth breeds mistrust, conflict and inequity throughout most of the world. (see Lewis)

So nation-systems in the future would be more vital and economically healthy by reverting their focus to economic sustainability (V=R:N) rather than economic growth. A balanced Vitality Ratio can ensure sustainability.

### 10. Implementing the Vitality Ratio

Nation-building is and has always been a work in progress. The data surrounding the Vitality Ratio, likewise, will always be a work in progress, although the basic variables—R (resources) and N (needs relating to people and products)—will not change, providing as they do a new and useful transformative process to ensure the economic vitality of nation-systems.

It would not be possible for this proposal—nor would it be necessary for the initial implementation of the Vitality Ratio—to list all methods of quantifying all people and products that are part of a nation-system at a given time and all the resources it consumes. Implementation of the Vitality Ratio would be a gradual building process. Its usefulness or effectiveness would grow in proportion to how comprehensive are the data-gathering, data-processing techniques. Once implemented, even on a small scale initially, the running ratio would be useful, and that usefulness would grow along with the scope of the data base and the methods of gathering and implementing the data.

In other words, it would not be necessary or even feasible for central teams of engineers to know everything there is to know about all material and energy measurements associated with all people and products in a nation-system and the resources they use, especially in the early implementation of the Vitality Ratio.

Eventually it would become a distributed system in which engineers and others from each field of endeavor would provide compatible data from their specific fields. Central offices would simply receive the data, ensure its compatibility (compatible data formats and units of measure), and submit it to the algorithm that drives the Vitality Ratio. This central process is the main focus of this patent, although the data-gathering process is important as well, especially in the initial implementation of the Vitality Ratio.

The Vitality Ratio would not deal with the monetary valuation of things. Money is a subjective, abstract measure of worth and as such, arguably, a major reason why existing economic systems do not work well. The Vitality Ratio deals with more substantial things—products on a shelf, their composition, number of people in a family, what they consume, barrels of oil estimated in a given reserve . . . that sort of thing.

The Vitality Ratio would not specify what people should eat (recommended daily allowances), what products they should use, or what resources should be used to create products, except insofar as broad measures recommended to sustain a balanced ratio (keeping needs in line with resources), in which case alerts will be issued by the system with options that regulators could consider, perhaps to limit population growth or to switch to alternative products or to acquire more resources. The Vitality Ratio simply tracks what people do eat, what products they do use, and what resources are used to create products. If a low-ratio condition is detected (if needs exceed resources), then alerts are issued with broad recommendations.

These are some of the specific concerns that will be addressed when implementing the Vitality Ratio:

Use existing databases until the Vitality Ratio is fully operational. Ideally the Vitality Ratio and associated information-gathering will someday be as basic a part of all nation-systems and their subsystems as budgets and shopping lists are to many families. Global standards will be in place to quantify demographics, products, and resources in dynamic, compatible detail, and it will be routine at all levels of society to keep track of the variables appropriate to those levels and to the groups therein. The distributed information, then, will flow smoothly to central processing offices running the Vitality Ratio. That elaborate system will evolve naturally, with the best-suited programming language, hardware, and operating system of the day, if and when the Vitality Ratio is adopted.

Meanwhile, there are processes in place in all industrialized societies to quantify people (demographics), products (inventories), and resources to a large degree. To implement the Vitality Ratio in today's world, on a limited scale, static data bases developed by government (see US Census Bureau), agriculture, business, industry, the United Nations, and other social systems can be used, and the information fed to central offices set up for the Vitality Ratio. Engineers at these central locations would receive the wide-ranging data, adapt it all into a compatible format, and submit it to the ratio. Granted, it will be cumbersome at first, but it can develop over time, gradually becoming more fluid and effective.

Handle different units of measure and data formats. Today there is diversity not just among measuring units (metric, US, Japanese, Chinese, Thai . . . ) but among data formats used by computers (from basic binary, to coding systems such as ASCII or Unicode, to graphics produced by raster or vector, to digital audio and video and multimedia file formats, to transfer protocols such as TCP/IP or UDP . . . ). Techniques are available to handle both types of diversity—to convert measuring units (see Gershtein, 2005) and to mediate among diverse data formats (see Ockerbloom; 1998, 2004, 2011). Examples of currently accessible information that reflects today's diversity relating specifically to resources and products:

Global fishing—measured in weight (pounds, kits, tons), volume (crans, gallons, cubic feet, herring barrels, bushels), density (pounds/cubic feet), and stowage rate (cubic feet/ton), taking into account whole fish, gutted fish, fish muscle, fish fillets . . . (see FAO, GRID/UNEP).

Timber harvest—measured in volume (cubic feet, board feet, cubic metres, metric tonnes, cylinder content based on radius or circumference) and weight (tons, tonnes, kilograms) taking into account old growth, young growth, round wood or sawn wood, wood density, moisture content, with or without bark . . . (see UNECE, Global Wood).

The complexity and incompatibility of systems in use today to measure products and resources would make the initial implementation of the Vitality Ratio cumbersome, but proceeding slowly and carefully, those obstacles would steadily be overcome.

The technical problems relating to diverse computer data formats are already mostly overcome today by the many international standards bodies, including IEEE, IETF, ISO, ITU, OASIS, W3C, XSF, AIIM, and ASTM.

Monitor population, products, and resources. Monitoring population refers only to general demography (birth, migration, aging, gender, death . . . ) and not to what are generally considered to be demographic profiling issues (nationality, religion, ethnicity) and privacy issues (income, health history, education level, Internet habits, TV viewing patterns . . . ). Monitoring products ultimately would be a complete inventory of the national infrastructure. It would include product management (see Wikipedia), automated product tracking (see Blanchard, 2006), product distribution (see Wikipedia), product inventory (see Dirks, 2012), and other product-related statistics. Monitoring natural resources could follow IFPRI's PRMS model, or Policy Relevant Monitoring Systems (see Haell et al, 2001), which involves systems designed specifically to manage and monitor natural resources in a comprehensive way.

Again, monitoring the variables of the Vitality Ratio may be cumbersome at first, but steady progress will be made.

Distinguish products from resources. A natural resource ceases to exist once it is ingested by the social system—that is, once it is integrated into people (e.g. as food or water) or into products (e.g. through manufacturing). There has to be a clear delineation between resources and products. For example, fertile soil is a resource, although fertilizers applied to the soil are products. Crops growing from the soil are products, as are domestic livestock that graze the land. A mushroom grown in a domestic greenhouse is a product. Growing wild it's a resource until it's eaten by a hiker (to become part of a person) or processed (to become a product). Grown in a foreign greenhouse a mushroom is a resource until it's imported, then it becomes a product. The status of every product and resource has to be tracked. A natural analogy to this is how Vitamin D, also called calcitrol, can be either a hormone (if produced in the body) or a vitamin (if produced outside the body and ingested as a nutrient, as in a slice of cheese). The body's hormones (such as calcitrol) are akin to a nation-system's products, and vitamins (such as vitamin D) are akin to a nation-system's resources.

Track resources to products. Tracking resources as they become processed for use in the nation-system is important. Some resources, such as ocean fish, are easy to track, as they are processed primarily into fish products to be consumed by people. Other resources are more difficult to track. Petroleum, for example, is processed into a variety of fuels, lubricants, plastics, fertilizers, pesticides, herbicides, cleaning agents, detergents, explosives, packing materials, paints, artificial fabrics, synthetic rubber, asphalt, and paraffin wax. (see Joaquin) In any case, the entire production cycle is tracked as resources become products.

Track recycled products back to resources. Everything that can be recycled should be recycled. When recycled products become resources, they move from one side of the ratio [N] to the other side [R]. (see EPA, 2005)

Avoid duplication in product nesting. A product is part of the equation until it is integrated either into a person (e.g. as food or medicine) or into a higher-level product, at which point it disappears from the equation. A capacitor, for example, would be a product and represented as part of system needs until it's integrated into a circuit board, at which time the capacitor is removed from the equation and the circuit board becomes a product (ideally with a manufacturing bill of materials defining its components). When the circuit board is built into a laptop computer, the circuit board is removed from the equation and the computer (with its manufacturing bill of materials) becomes a product in the equation. (see Wikpedia)

Avoid complications of system nesting by looking at the national level. Theoretically the Vitality Ratio can apply to any social system of any size. The natural resources of a family can include the things they buy at the store, and once those things are brought home and put away in the fridge or pantry, they're products. Those same things on the store shelves that are resources of the family, are products of the city and the nation-system where the family lives. So implementing the Vitality Ratio could involve coming to grips with the nested structure of life. These complications could be alleviated if we apply the Vitality Ratio only to nation-systems, rather than to the smaller social systems that compose nation-systems.

We focus on nation-systems also instead of on the larger systems such as world religions that crosscut and overlap with nation-systems. A special problem is presented by multinational treaties and transnational corporations, which share resources or products (factories, distribution channels . . . ) or work force across national borders. To overcome this problem, in the early stages of the Vitality Ratio implementation, only people and products currently located within the national borders of a nation—regardless of product ownership or a person's citizenship—would be included in the Vitality Ratio of that nation-system.

Ideally, the Vitality Ratio will eventually be implemented at the world level (see below) to monitor the economic vitality of all mankind, at which time these nesting-related complications will disappear. At that time the ratio will monitor all people on Earth and all the products they use on one side of the ratio, and all resources the nation-system of humanity consumes to sustain itself on the other side of the ratio.

Apply only to integrated societies. The Vitality Ratio can be implemented only in nation-systems that are already integrated with an infrastructure of communication and transportation networks (especially a well-spread computer network); electricity, food and water readily available to everyone, and so on. It would not work in pre-modern or primitive cultures. (see UNDP, Spagnoli)

Apply worldwide if and when possible. There may be limited success trying to implement the Vitality Ratio in single nation-systems. It can't be completely successful until it's implemented at the world level, bringing all nation-systems into a single, integrated society of humankind. The reason is that people and products move fluidly among nation-systems in the course of tourism, trade, and migration, making it nearly impossible to keep the “needs” variable steady. One nation-system might implement the Vitality Ratio and keep its birthrate at a safe level, while other nation-systems nearby let population grow out of control, compelling the crowds to overflow into the more stable nation-system, thus destabilizing it.

So the Vitality Ratio ultimately could be implemented at the planetary level, where all nation-systems may be fitted with modern communication, transportation, and energy infrastructures. Then, when all nation-systems are up to speed, the global network may be implemented and monitored by many nation-systems and corporations working together, probably through the United Nations.

Meanwhile, individual nations and blocs of contiguous nations could adopt the Vitality

Ratio successfully if they are willing and able to control immigration tightly and to deal with the complications presented (as explained above) by large, overlapping systems such as multinational treaties and transnational corporations.

### REFERENCES

Blanchard, John. Better Product Tracking and Tracing. http://www.automationworld.com/information-management/better-product-tracking-and-tracing
Brinkley, Paul Andrew. U.S. Pat. No. 5,963,919. Inventory Management Strategy Evaluation System and Method.
Caves, Douglas W. et. al. The Economic Theory of Index Numbers and the Measurement of Input, Output, and Productivity. (Econometrica, November 1982)
Coelli, Tim J. et. al., Total Factor Productivity Growth in Agriculture: A Malmquist Index Analysis of 93 Countries, 1980-2000. (University of Queensland, September 2003)
Dirks, Courtney (Meylah). Product inventory. http://meylah.com/meylah/managing-your-product-inventory
Dulaney, Earl. U.S. Pat. No. 6,341,269. System, Method And Article Of Manufacture To Optimize Inventory And Merchandising Shelf Space Utilkation.
EPA, The Quest for Less; a Teacher's Guide to Reducing, Reusing, and Recycling http://www.epa.gov/osw/education/quest/pdfs/qfl_complete.pdf
Factorylnsite.biz. Automated product tracking http://www.factoryinsite.biz/automated product tracking.htm
FAO. Units of Measure in the Fishing Industry. http://www.fao.org/wairdocs/tan/x5898e/x5898e01:htm
Feigin, Gerald. U.S. Pat. No. 6,006,196. Method of Estimating Future Replenishment Requirements and Inventory Levels in Physical Distribution Networks.
Feldman, Martha, Organizational Routines as a Source of Continuous Change. (2000) http://www.mendeley.com/research/organizational-routines-as-a-source-of-continuous-change/
Gershtein, Sergey and Anna, 2005. Conversion Tables/Unit Conversion Online http://www.convert-me.com/en/
Global Wood. Timber Technology and Knowledge Center. http://www.globalwood.org/tech/tech_{—}01001.htm)
GRID/UNEP, 2009. State of the World Fisheries and Aquaculture. http://maps.grida.no/go/graphic/state-of-world-fisheries-and-aquaculture
IFPRI. Monitoring resources (http://www.ifpri.org/sites/default/files/pubs/divs/eptd/dp/papers/eptdp73.pdf)
ITU, Industry Groups Callfor. Global Standards to Shape the Digital Home. (2006). http://www.itu.int/ITU-T/newslog/Industry+Groups+Call+For+Global+Standards+To+Shape+The+Digital+Home.aspx
Joaquin, Sheryl. Petroleum: Its Uses and Benefits. http://ezinearticles.com/?Petroleum---Its-Uses-And-Benefits&id=775224
Kagami, Akira. U.S. Pat. No. 5,237,496. Inventory Control Method and System.
Kosala, Raymond et. al. Web Mining Research: A Survey. (SIGKDD Explorations, July 2000) http://www.umiacs.umd.edu/˜joseph/classes/enee752/Fa1109/survey-2000.pdf
Lewis, Al. Grantham wonders if Marx was right after all. (MarketWatch, Feb. 29, 2012.) http://www.marketwatch.com/story/grantham-wonders-if-marx-was-right-after-all-2012-02-29
Mather, Nancy et. al. Behavior Modification in the Classroom. (2001) http://cdl.org/resource-library/pdf/behavior_modification classroom.pdf
Nymity. The Demographics of Privacy. (http://www.nymity.com/Free_Privacy_Resources/Previews/ReferencePreview.aspx?guid=39c228c3-100e-4cde-958c-ee8be4647ceb),
Ockerbloom, John, 1998, 2004, 2011. 1998. Mediating Among Diverse Data Formats. http://reports-archive.adm.cs.cmu.edu/anon/1998/CMU-CS-98-102.pdf 2004. Mediating Among Diverse Data Formats (Iodate). http://www.docstoc.com/docs/33499789/Mediating-Among-Diverse-Data-Formats 2011. Building a Global Open Network of Discovery http://works.bepress.com/john_mark_ockerbloom/14/
Pearson Higher Ed, Cellular, Elemental, and Molecular Building Blocks of Living Systems. http://www.pearsonhighered.com/assets/hip/us/hip_us_pearsonhighered/samplechapter/0136020038.pdf
Schmidt, Maren, Three Ways to Change Behavior. (2012) http://www.kidstalknews.com/2012/01/three-ways-to-change-behavior.html
Spagnoli, Filip, Statistics on International Development Aid. http://filipspagnoli.wordpress.com/stats-on-human-rights/statistics-on-poverty/statistics-on-international-development-aid/
UCSF Medical School, Setting goals and shapingyour reality. (2000) http://medschool.ucsf.edu/latino/pdf/CBTDEN/instructor/act4.pdf
UNDP (United Nations Development Programme). Stat Planet Human Development Index Map. http://hdr.undp.org/en/data/map/
UNECE (United Nations Economic Commission for Europe)—Geneva Timber and Forest Discussion Paper 49 http://www.unece.org/fileadmin/DAM/timber/publications/DP-49.pdf
US Census Bureau. US Census 2000 on All Countries. http://www.allcountries.org/uscensus/
Wikipedia. Bill of Materials http://en.wikipedia.org/wiki/Bill_of_materials
Wikipedia. Product Management http://en.wikipedia.org/wiki/Product_management

1-23. (canceled)

24. A process to transform a social system into a more vital and sustainable living system by defining it as a nested living system that is composed of people and products as basic building blocks and that consumes natural resources to satisfy the material and energy needs of the people and products, by defining a person as a living physical human being with its bodily energies and capabilities, by defining products as living or nonliving things that people use to participate in the activities going on in the social system, by defining natural resources as outside the social system (i.e. not people or products of that social system), by monitoring the availability of natural resources, by monitoring the resource needs of the people and products, by establishing a ratio between the needs and the natural resources available to satisfy those needs, by using that ratio as a determining factor of a social system's vitality, by using program code on a non-transient computer-readable medium executed by a processor within a computer network to analyze information pertaining to the ratio, by generating an on-going economic vitality status of the social system based on analyzed information, by issuing alerts with recommendations for remedial action when the need for any particular resource exceeds availability, and in so doing to improve and/or ensure the social system's vitality and sustainability in perpetuity, as long as the process continues.

25. The method of claim 24, wherein people are humans taking part in activities of a social system, products are quantifiable living or nonliving things that people in the social system use, and resources are outside a social structure of people and products and are useful and available to the social system.

26. The method of claim 25, wherein products and natural resources can be material or energy in form.

27. The method of claim 24, wherein analyzing information further comprises discerning products from resources.

28. The method of claim 27, further comprising tracking a status of products and resources.

29. The method of claim 28, wherein the status of resources changes over time from resource to product.

30. The method of claim 29, wherein the status of recycled products can change over time from product to resource.

31. The method of claim 24, wherein the vitality ratio is V=R:N and tracks only people, products, and resources.

32. The method of claim 31, wherein the economic vitality (V) is determined by the ratio between resources (R) for the social system and resource needs (N) of the people and products constituting the social system.

33. The method of claim 24, wherein a social system is a nested system containing various levels of subsystems, some of which might be social systems.

34. The method of claim 24, wherein a social system at the national level consists of the people and products that are involved in the activities within the borders of a nation-state, and the infrastructure of people and products of that nation-level social system can be referred to as a nation-system.

35. The method of claim 24, wherein a social system implementing the method is transformed by the rules, routines, goals, and standards inherent in the method.

36. The method of claim 35, wherein the transformation is to a state of vitality and sustainability as resource needs are kept in line with resource availability.
